(19) United States
(12) Patent Application Publication
(10) Pub. No.: US 2003/0098230 A1
(43) Pub. Date: May 29, 2003

(54) Non-thermal plasma reactor with filter

(75) Inventors: John Sydney Carlow, Southampton (GB); Stephen Ivor Hall, Oxford (GB); Michael Inman, Abingdon (GB); James Timothy Shawcross, Charlbury (GB)

Correspondence Address: LAW OFFICES OF WILLIAM H. HOLT, Unit 2, First Floor, 1423 Powhatan Street, Alexandria, VA, 22314, US

(73) Assignee: ACCENTUS PLC.

(21) Appl. No.: 10/303,789

(22) Filed: Nov. 26, 2002

(30) Foreign Application Priority Data
Nov. 29, 2001 (GB) 01 28530.3
Sep. 21, 2002 (GB) 02 21981.4

(51) Int. Cl. B01J 19/08

(52) U.S. Cl. 204/164; 422/186.04

(57) ABSTRACT

A reactor for non-thermal plasma assisted treatment of a gaseous medium incorporates at least one electrically conducting mesh filter element positioned so that gaseous medium passes therethrough. At least one dielectric barrier layer provides for a dielectric barrier type discharge, when an electrical power supply is connected to the electrodes to generate the plasma.

The invention relates to a non-thermal plasma reactor and in particular to such a reactor combined with a filter for the treatment of gaseous media such as exhaust gases from an internal combustion engine to remove or reduce particulate pollutants such as carbonaceous particulates. Such products are encountered in the exhausts of internal combustion engines and effluent gases from incineration or other industrial processes, such as from the pharmaceutical, food-processing, paint manufacturing, dye manufacturing, textiles and printing industries. Coal-fired power stations and gas turbines also produce effluent gases which can be treated in this way.

There is a requirement for improved methods of trapping and removing particulates from exhaust gas streams. One of the main challenges with achieving highly efficient filtration of particulates from gas streams is minimising the associated pressure drop across the filter caused by the build up of particulates, by successfully regenerating the filter, before the filter clogs up. When a filter is incorporated into a non-thermal plasma reactor the latter can be powered continuously or intermittently when regeneration is required. A number of reactor devices have been proposed employing non-thermal plasmas by themselves or in combination with catalyst materials, the so-called plasma-catalyst approach, for treatment of diesel exhaust emissions. The combination of a plasma with a substrate (for example, a filter material) that acts as a particulate trap is known. Particulates trapped in this way can be oxidised by the plasma in the presence or absence of catalysts. Species implicated in the mechanism of oxidation are discussed in WO 01/30485 and the article by Thomas et al, ‘Non-thermal Plasma Aftertreatment of Particulates—Theoretical Limits and Impact on Reactor Design’, SAE 2000-01-1926 and include O, OH, O₃, NO₂, NOₓ and electronically excited species. The plasma catalyst approach can also be used for the removal of nitrogen oxides by selective catalytic reduction. Examples of the use of this plasma catalyst approach are described in WO 00/43102, WO 00/71866 and WO 02/074435.

It has been demonstrated that non-thermal plasmas can be generated when the substrate material contained between electrodes is in the form, for example, of spheres, for example in a packed bed reactor such as a ferroelectric bed reactor or in a dielectric barrier reactor that contains for example spherical dielectric material such as alumina beads. Other forms of substrate material have been proposed such as ceramic meshes, fragments, fibres or the like and these are described in WO 01/59270 and WO 00/51714.

Two-stage approaches can be used for the treatment of exhaust gases and can involve the use of plasma to convert NOₓ to NO₂ that is then used to oxidise, in the presence or absence of a catalyst, particulates that are trapped on a substrate such as a mesh that may be positioned inside or outside of the plasma region of the plasma reactor. Examples of multi-stage approaches including the two-stage approach are described in WO 01/76733 and the reaction of NO₂ with carbonaceous particulates is discussed in WO 00/43102.

U.S. Pat. No. 4,902,487 and the article by Cooper and Thoss “Role of NO in Diesel Particulate Emission Control” published as SAE 890404, 1989 also describe a two-stage system in which diesel exhaust is passed over an oxidation catalyst, Pt, that oxidises NO in the exhaust gases to NO₂ after which NO₂ reacts with carbonaceous particulates in the exhaust stream that are trapped on a filter. The NO₂ effectively combusts the deposited carbon particulates and is thus reduced and the products of this reaction are NO, NO₂, CO and CO₂. A combustion catalyst for example a lanthanum oxide, caesium oxide doped vanadium pentoxide on the filter is used to lower the combustion temperature of the carbon/NO₂ reaction to around 265° C.

U.S. Pat. Nos. 5,853,437 and 6,063,150 disclose a filter for trapping particulates produced in the exhaust gases of a diesel engine. The filter includes a number of sintered metal strips sewn to a sheet of inorganic material. The exhaust gases are passed through the filter and the particulates are trapped on the metal strips. The filter is then regenerated by passing a current through the metal strips to heat them to about 600° C. and burn off the trapped particulates. Typically the amount of exhaust gas passed through a given section of filter may be reduced while the filter is regenerated in order to reduce the amount of heat lost by convection.

The present invention is based upon the appreciation that for efficient filtration using non-thermal plasmas there are requirements for substrate materials in the form of one or more mesh filter elements that can act as filtration media when placed in or around the plasma region or otherwise so as to be acted upon by the plasma. The substrate materials may be positioned to enhance trapping of particulate materials either through the physical properties of the substrate by itself or in combination with the effect of the substrate in modifying the plasma distribution, for example to produce a more uniform plasma distribution or, alternatively, to effect concentration of the plasma in selected regions of the substrate, for example in regions where carbonaceous particulates are concentrated. In order for trapping to occur, the gaseous medium being treated by the reactor is passed through at least one mesh filter element.

It is an object of the present invention to provide a non-thermal plasma reactor that addresses the problem of the removal of particulates from gaseous media, especially exhaust gases.

The invention provides a reactor for non-thermal plasma assisted treatment of a gaseous medium, which reactor comprises electrodes defining a space therebetween, through which space gaseous medium is passed in use of the reactor, at least one dielectric barrier layer arranged to provide for a non-thermal plasma of the type referred to as a dielectric barrier type discharge, when an electrical power supply is connected to the electrodes to apply an electrical potential across the said space, and at least one electrically conducting mesh filter element positioned so as to be acted upon by the plasma and so that the gaseous medium passes therethrough.

The gaseous medium is any gaseous medium which comprises unwanted particulates. For example, exhaust gases from a combustion engine or gases resulting from incineration or the operation of a coal-fired power station.

Each pair of electrodes is provided with a dielectric barrier. The dielectric barrier is a layer of material which shields adjacent electrodes from one another thus preventing arc discharges between the electrodes. Typically the dielectric barrier is in contact with an electrode. Where the reactor has a stack or series of electrodes, alternate electrodes are typically encased in or surrounded by dielectric barrier material.

In one embodiment, the invention provides a reactor for non-thermal plasma assisted treatment of a gaseous medium, which reactor comprises electrodes defining a space therebetween, through which space gaseous medium is passed in use of the reactor, at least one dielectric barrier layer arranged to provide for a non-thermal plasma of the type referred to as a dielectric barrier type discharge, when an electrical power supply is connected to the electrodes to apply an electrical potential across the said space, and at least one electrically conducting mesh filter element extending across the said space.

Suitable meshes can be fabricated from metals including stainless steel, Fecralloy® and nickel. Examples of aperture sizes are in the range 25-500 microns (μm), wire diameters in the range 0.025-0.3 millimetres (mm). Various weaves can be used, designated plain, twilled, duplex as produced by G Bopp AG (Zurich) and Robinson Wire Cloth Limited (Stoke on Trent). Meshes may be described as gauzes and can be prepared also from electrically conducting non-metallic fibres.

The mesh filter element may comprise woven metal filter cloth, metal fibres, sintered metal fibre material or sintered metal powder material. One example of woven metal filter cloth is that made by G Bopp & Co. Examples of sintered metal fibre materials are those obtainable from Porvair Microfiltrex (Fareham, UK) and Bekhaert (Belgium) made of stainless steel, Monel®, Inconel®, Hastelloy® and Fecralloy®. Stainless steel discs made by sintering powder are available from Martin Kurz & Co Inc and sold under the name Dynapore™ SPM™. Stainless steel is in general a preferred metal for the mesh.

Each mesh filter element may extend all the way across the space between the electrodes or it may extend partially across the space. Elements may all be located at one side of the space, for example in contact with one electrode or dielectric barrier, or elements may be located on both sides of the space. The elements in any one reactor may all extend the same amount across the space or they may extend across different amounts of the space and may include some elements that extend all the way across the space. The elements may be parallel to or perpendicular to the electrodes or the elements may be positioned diagonally across the space between the electrodes. In each case the gaseous medium is fed into the reactor such that it passes through at least one element.

In a preferred arrangement according to the invention, there are two dielectric barrier layers, one on each side of the said space, and the or each mesh filter element extends across the space and into contact with each of the respective dielectric barrier layers. The or each mesh filter element may have a curved configuration, and may advantageously have a corrugated form.

The space contained by the meshes can contain other filtration media such as high efficiency particulate air filters (HEPA filters) and/or catalyst materials.

In another arrangement according to the invention, there is a single dielectric barrier layer and the or each mesh filter element extends from contact with the dielectric barrier layer across the said space and into physical and electrical contact with an electrode, thereby causing an intensification of plasma formation in the neighbourhood of contact between the or each mesh electrode and the dielectric barrier layer. The or each mesh filter element may be inclined at an angle to the surface of the dielectric barrier layer. In such an arrangement, the mesh filter element forms part of the electrode as it makes electrical contact with the electrode. The part of the electrode that bounds the plasma region may be made of a solid or mesh material or a combination thereof.

Preferably there is a plurality of such inclined mesh filter elements spaced apart. These may be arranged so that there is no overlap of the projection onto the dielectric barrier layer of one mesh filter element with the projection of an adjacent mesh filter element. Alternatively, the arrangement may be such that there is overlap between such projections of adjacent mesh filter elements whereby formation of plasma is concentrated in a region between the extent of the dielectric barrier layer from the point of contact of one mesh filter element to the point of contact of the next adjacent mesh filter element and the acutely inclined surface of one of the said adjacent mesh filter elements.

The aperture size of the mesh filter elements is chosen to achieve highly efficient filtration while controlling back pressure and maintaining durability of the filter material. However, it is convenient to arrange a plurality of mesh filter elements with a graded variation in mesh aperture size along the length of the flow path for the gaseous medium, the variation being typically such as to reduce progressively the aperture size in the direction of gas flow. The mesh filter elements may be provided with a catalyst surface coating to act as a carbon combustion catalyst to aid removal of trapped particulates. It will be appreciated that catalysts other than carbon combustion catalysts can be used for removal of components of exhaust gases other than particulates, for example carbon monoxide, hydrocarbons and nitrogen oxides.

In a further embodiment, the present invention provides a non-thermal plasma reactor for the treatment of a gaseous medium comprising two electrodes and space therebetween, the electrodes being provided with a dielectric barrier therebetween, wherein gaseous medium is fed into the space between the electrodes and leaves the space between the said electrodes through an electrode at least part of which comprises a mesh material which thereby provides a said mesh filter element.

The reactor may have two electrodes or more. The electrodes may be in the form of a stack or series of flat plates or may be a series of concentric electrodes or any other suitable configuration. Where the reactor has just two electrodes, one electrode is typically protected by the dielectric barrier, for example it is in contact with it and the barrier is between the two electrodes. The other electrode is typically the electrode comprising mesh material, also referred to as the mesh electrode.

Generally, it is the electrodes that are not in contact with (surrounded by) or adjacent to a dielectric barrier which comprise a mesh material.

The gaseous medium is fed into the reactor through an inlet such that it passes into the space between the electrodes. This is the space in which the plasma is formed. The gaseous medium is then constrained to pass through the or one of the electrodes comprising a mesh material in order to exit the reactor. The mesh material acts to trap at least some of the particulates from the gaseous medium on the electrode. Surprisingly it has been found that the particulates are then converted efficiently to carbon monoxide and carbon dioxide by the action of the plasma.

The electrodes through which the gaseous medium passes are porous. They are made of or comprise a mesh material which is able to trap particulates. Typically the whole electrode is made of mesh material but an electrode with just a portion of mesh material for the exhaust gases to pass through is also possible. Suitable mesh materials are the same as those described above for the mesh filter element and include wire mesh, woven metal filter cloth, metal fibres, sintered metal fibre material and sintered metal powder material.

The electrode may be made of a combination of mesh materials. For example, two or more materials may be used in layers.

The electrode comprising a mesh material may be corrugated or otherwise shaped so as to achieve a greater surface area of electrode in the available space. The corrugated material may be positioned so as to touch the dielectric barrier protecting the other or the adjacent electrode at one or more points. Alternatively, the corrugated electrode may be spaced apart from the dielectric barrier.

Successive layers of an electrode may each be flat or corrugated. Thus, an electrode may comprise layers that are parallel to one another or may comprise a mixture of corrugated and curved or flat layers of mesh material. In one embodiment a stronger mesh material may be used as the support for a finer corrugated mesh material.

Any part of the electrode that is not made of mesh material may be made of any solid conducting material such as sheet metal, for example stainless steel.

In a preferred embodiment of the invention the space between the or each pair of electrodes is empty. The gaseous medium passes though the space but there is no filling material or catalytic material in the space between the electrodes for it to pass through or over.

In another embodiment some or all of the space between the electrodes is filled by a filling material. The filling material is any material which improves the performance of the reactor. It must be able to withstand the temperatures at which the reactor is operating. The filling material is a dielectric material. Suitable materials include ceramic materials such as, but not exclusively, oxides for example aluminas, titanias, silicas, zirconia, glasses, glass ceramics, mixed oxides, complex oxides and metal doped oxides. An example of the latter is silver-doped alumina. The filling can be in the form of spheres, pellets, extrudates, fibres, blanket, felt, sheets, wafers, frits, coils, foams, graded foams, membrane, ceramic honeycomb monolith or granules.

The filling material may act as a filter material, or as a support for a catalyst, or as a catalyst itself or a mixture thereof. Combinations of different catalysts can be used. Vanadates such as metavanadates and pyrovanadates and perovskites are examples of catalysts. Zeolites and metal containing zeolites have a catalytic function. Examples of zeolites are ZSM-5, Y, beta, mordenite and examples of metals that can be used in metal containing zeolites are copper, silver, iron, cobalt. Promoting cations such as cerium and lanthanum can be present in the zeolite composition. The catalyst can be in the form of any of the shapes mentioned above for the filling material or as a coating on or contained within a dielectric material. A preferred filling material is a dielectric fibre material such as Saffil (95% by weight alumina: 5% by weight silica) in the form of, for example, a blanket or vacuum formed shape.

In a preferred embodiment the filling material is a material which has a lower filtration ability than the mesh electrode per unit thickness.

The filling material may be coated with a catalyst such as a catalyst for the conversion of NO to NO₂ or NOₓ (NO and NO₂) to N₂ in order to improve the processing of noxious exhaust gases in the gaseous medium. The filling material or the mesh material of the electrode may be coated with a catalyst for the conversion of carbon to carbon monoxide and/or carbon dioxide.

In one embodiment of the invention the gaseous medium is further processed after passing through the mesh filter element or mesh electrode in order to remove carbon monoxide. A proportion of the carbon monoxide is formed by the oxidation of the particulates trapped on the mesh electrode.

To remove the carbon monoxide the gaseous medium may be passed over a catalyst for oxidising the carbon monoxide to carbon dioxide such as platinum, tin oxide or a platinum doped tin oxide. The catalyst may be present on the mesh filter element or mesh electrode, for example a mesh electrode formed of Fecralloy® that may be treated by first heating in air to produce a surface alumina film after which a coating that acts as a catalyst for the conversion of carbon monoxide to carbon dioxide is applied. The catalyst can be deposited from a solution or from a suspension or from a colloidal dispersion or from a washcoat (that is a suspension of a coarse powder in a colloidal dispersion) for example by a sol-gel process. A calcination step is typically required to increase the adhesion of the catalyst coating onto the metallic substrate. A suitable catalyst can also be placed in the path of the gaseous medium downstream of the mesh electrode, for example in the outlet of the reactor or in a further downstream gas processing unit. The catalyst can act as a hydrocarbon oxidation catalyst for example platinum on alumina or for the selective reduction of nitrogen oxides in the presence of hydrocarbons for example metal doped zeolites such as indium doped ZSM-5, or silver-doped alumina. The catalyst can also act as a carbon combustion catalyst. The catalyst can also act as an adsorber catalyst for the conversion of nitrogen oxides to nitrogen. Combinations of different catalysts can be used. Gamma alumina is a preferred crystalline phase when alumina is the support material.

A suitable catalyst may also be placed in a gas processing unit upstream of the reactor in order to treat the gaseous medium before it enters the reactor.

One or more reactors of the present invention may be used as part of a system for treating exhaust gases. The system may contain catalysts.

One or more reactors of the present invention may be used to form an array of reactors. Each reactor in the array may be powered continuously or intermittently. Where the reactors are used intermittently the gaseous medium may be diverted between reactors for trapping and regeneration. Thus the gaseous medium is passed though the reactor and trapped on the mesh filter element. The gaseous medium is then diverted to another reactor while the first reactor is regenerated using a plasma. During the regeneration air or oxygen may be provided in the reactor.

Specific constructions of reactors embodying the invention will now be described by way of example and with reference to the drawings filed herewith, in which:

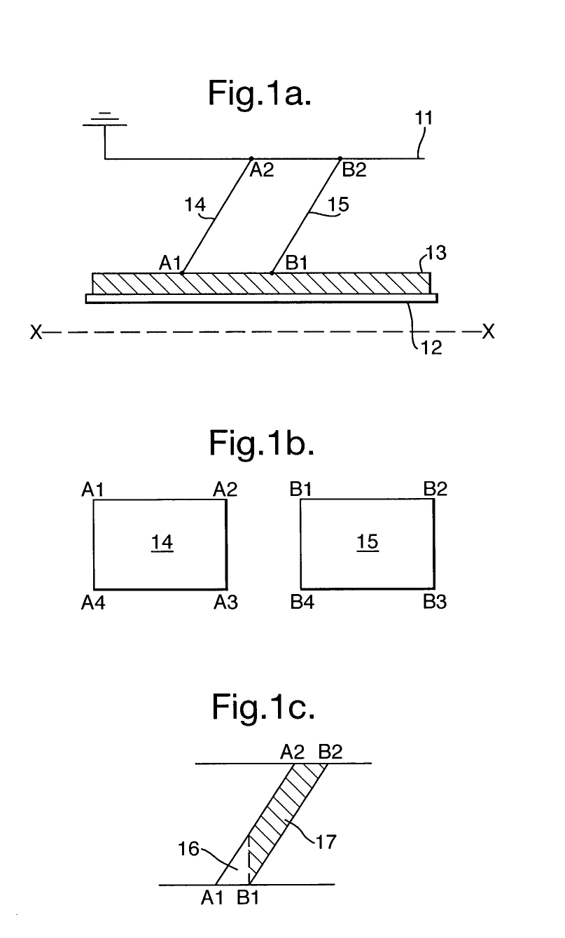

FIG. 1a is a diagrammatic cross-sectional view of part of a reactor,

FIG. 1b is a plan view of a pair of mesh filter elements, labelled to show their orientations in FIG. 1a,

FIG. 1c is a diagrammatic representation of a modification of the reactor shown in FIG. 1a,

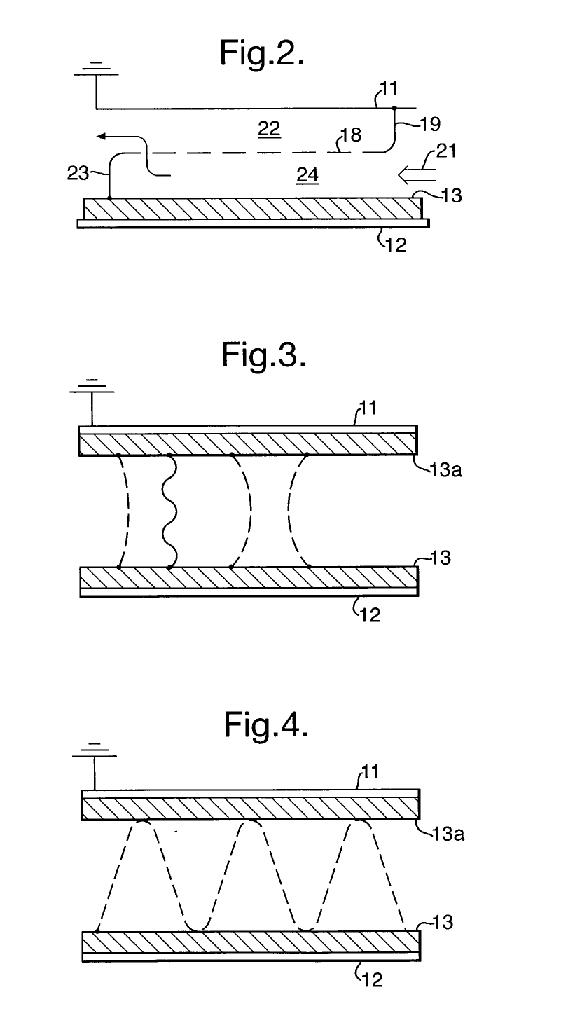

FIG. 2 is a diagrammatic cross-sectional view of part of a reactor with a modified form of mesh filter element,

FIG. 3 is a diagrammatic cross-sectional view of part of a reactor having two dielectric barrier layers and illustrating a variety of curved forms of mesh filter elements, and

FIG. 4 is a diagrammatic cross-sectional view of part of a reactor similar to FIG. 3 showing a corrugated form of mesh filter element.

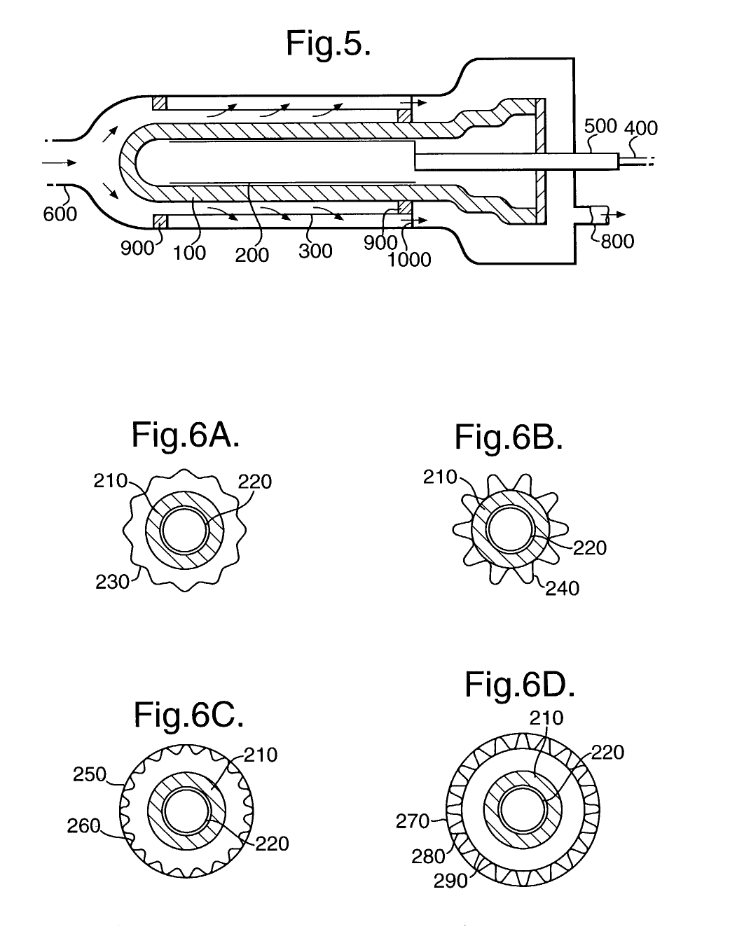

FIG. 5 is a cross-sectional view through a reactor.

FIGS. 6A, 6B, 6C and 6D are cross-sectional views of the type of reactor shown in FIG. 5 illustrating further embodiments of the mesh electrode.

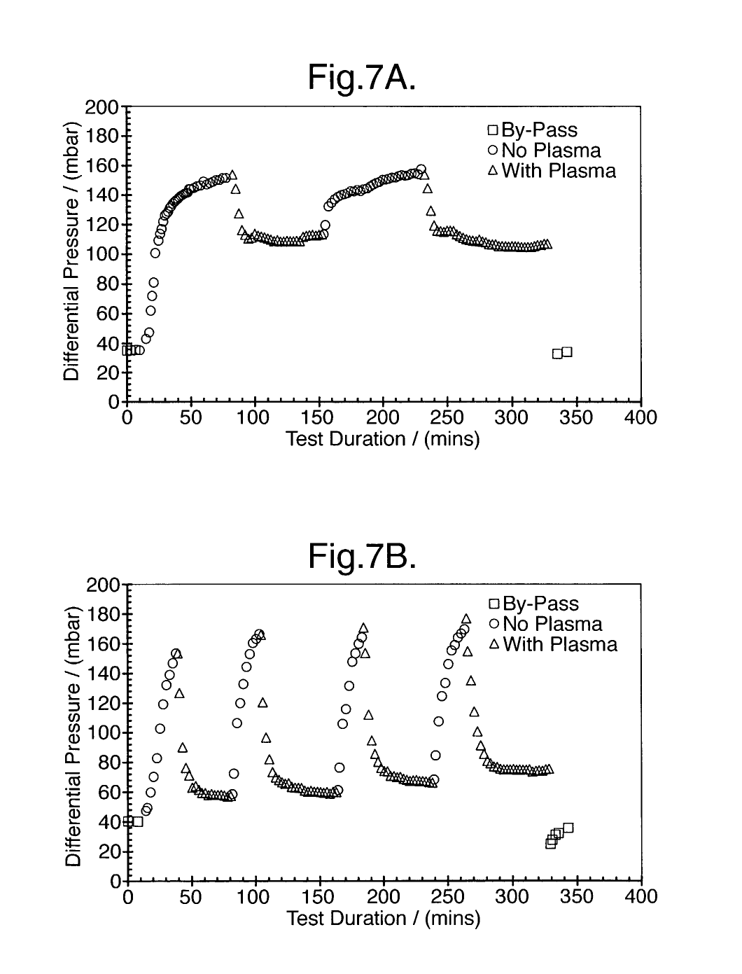

FIGS. 7A and 7B are graphs showing the change in differential pressure with time for a reactor of the type shown in FIG. 5 in the presence and absence of plasma.

Referring to FIG. 1a, there is shown an earth electrode plate 11 and a high voltage electrode plate 12 defining a space therebetween through which gaseous medium to be treated is passed during use of the reactor. A dielectric barrier layer 13 is provided in intimate contact with the electrode plate 12 so that when an appropriate electrical voltage is applied across the electrodes 11 and 12 a non-thermal plasma discharge is created in gaseous medium passing between the electrodes of the dielectric barrier reactor.

For filtering out particulates in the gaseous medium a multiplicity of electrically conducting mesh filter elements are provided, only two of which, 14,15, are shown in FIG. 1a. Each mesh filter element extends across the space from the dielectric barrier layer 13 to the earth electrode 11, to which the mesh filter elements are physically and electrically connected.

The reactor of this example has a rectangular box configuration, as is evident from FIG. 1b, which shows the mesh filter elements 14,15 in plan. The corner markings A1,A2,A3,A4 and B1,B2,B3,B4 respectively identify the orientation of the filter elements in FIG. 1a, in which gaseous medium may be caused to flow from right to left as seen in FIG. 1a (or from left to right).

The effect of this configuration, in which the electrically conducting mesh filter elements 14, 15 are in electrical contact with the earth electrode 11, is that the most intense plasma formation occurs in the regions of the edges A1-A4 and B1-B4 in the acute angles between the filter elements 14, 15 and the dielectric barrier layer 13. There will, however, be expansion of this plasma into the remainder of the space between the barrier layer 13 and the earth electrode 11.

As may be seen from FIG. 1a, the projection of mesh filter element 14 onto the dielectric barrier layer 13 does not overlap the corresponding projection of mesh filter element 15. FIG. 1c illustrates the effect where there is overlap of the projection of one mesh filter element onto the corresponding projection of the adjacent filter element. In this configuration, plasma is confined to the region, triangular in cross-section, referenced 16. No plasma is formed in the shaded region referenced 17. A high efficiency particulate air filter (HEPA) material can be contained in the plasma region (16) of FIG. 1c.

Particulates in the gaseous medium flowing through the reactor are trapped on the mesh filter elements and oxidised by the action of activated species in the plasma. This action can be enhanced by providing a coating of a catalytic material, such as cerium oxide, alkali-metal doped lanthanum oxide, vanadium oxide, vanadates or perovskites as described in PCT/GB01/00442. As described in that specification, catalytic activity can also be provided to assist in simultaneous conversion of nitrogen oxides to nitrogen and to assist in the conversion of other components of exhaust gases for example nitrogen oxides to nitrogen, hydrocarbons to carbon dioxide and water.

A convenient potential for application across the electrodes 11 and 12 for excitation of plasma is of the order of kilovolts to tens of kilovolts and repetition frequencies in the range 50 to 5,000 Hz, although higher frequencies of the order of tens of kHz can be used. Pulsed direct current is convenient for automotive use, but alternating potentials for example triangular or sine waves of the same or similar characteristics can be used. It is found that a potential of 20 kV is suitable for an electrode spacing of 10-15 mm although the voltage, frequency and power supply operating conditions are adjusted to the particular application, for example in cars, aircraft and buildings.

To improve trapping efficiency and reduce possible effects of clogging, the aperture sizes of a series of mesh filter elements may be graded to decrease in the direction of flow of gaseous medium. The operation of a non-thermal plasma may also provide electrostatic enhancement for the trapping capability of the meshes. Advantageously, flow of the gaseous medium is controlled to concentrate particle trapping in the regions where the most intense plasma is formed.

FIG. 2 illustrates a modified configuration of mesh filter element 18, which, as in FIG. 1a, provides an electrical connection between earth electrode 11 and dielectric barrier layer 13. However, the mesh portion extends parallel with the electrodes 11, 12 along the length of the reactor producing a uniform plasma volume. At one end, an impervious portion 19 extends into contact with the electrode 11, blocking passage of gaseous medium flowing in the direction of arrow 21 from direct access to the upper part 22 of the reactor space. At the other end, an impervious portion 23 links the filter element 18 to the dielectric barrier layer 13 and, correspondingly, blocks passage of gaseous medium from flowing directly out of the lower part 24 of the reactor space. With this configuration, gaseous medium is constrained to flow into part 24 of the reactor space, in which plasma is formed, and exit via the mesh portion of the filter element 18 into part 22 of the reactor space, in which no plasma is formed.

FIG. 3 illustrates further modified configurations in which electrode 11 is also provided with a dielectric barrier layer 13a and mesh filter elements extend across the space between the dielectric barrier elements 13 and 13a. The Figure illustrates a variety of curved or corrugated cross-sectional forms which may be adopted and which may provide enhanced trapping of particulates. In general, in any one reactor, an array of mesh filter elements will have matching shapes, the variety shown in FIG. 3 being for convenience of illustration, although it is, of course, possible that a combination of mixed shapes may be desirable. Key features described in FIGS. 1a, 1b, 1c and 2 may be incorporated into a dielectric barrier reactor containing two dielectric barriers as shown schematically in FIG. 3. A corrugated mesh can also be in the form of a wallflow filter of the type used for treating vehicle engine emissions where the ends of alternate channels are sealed and a metallic skin surrounds the circumference of the filter so that gases can only enter the filter axially through the channels.

FIG. 4 illustrates a further variation using a corrugated form of mesh filter element. Several elements shown in FIG. 4 may be combined to form a stack of mesh elements.

The invention is not restricted to the details of the foregoing examples. For instance, the reactor need not necessarily have a rectangular configuration. In some circumstances a cylindrical configuration is preferable. One such can be envisaged by the form of reactor generated by rotation of FIG. 1a about the dotted line X-X.

Alternatively, a reactor form such as described in PCT/GB00/01881 may be adopted, but in that case, since gaseous medium is guided to flow helically around the cylindrical reactor configuration, mesh filter elements incorporated into that design would need to extend in planes generally parallel with the axis of the cylinder. In the radial direction, such elements may be planar or curved or corrugated but also may have an inclination to the radial direction. Other reactors that may be adopted for use with meshes are described in WO 02/074435, and in WO 99/43419 and WO 99/47243.

FIG. 5 shows a reactor comprising a dielectric barrier (100) surrounding a high voltage electrode (200). The high voltage cable (400) is shielded (500) where it enters the reactor. The earth electrode (300) is made of mesh material. The gaseous medium flows into the reactor through an inlet (600). It flows into the space between the earth electrode (300) and the dielectric barrier (100). The gas is then constrained to pass through the mesh electrode in the direction indicated by the arrows in order to leave the reactor through the permeable structure (1000) and then through the outlet (800). The supports (900) hold the earth electrode in position within the reactor. The supports are also impermeable to gas and thus also constrain the gas to flow through the electrode made of mesh (300).

In a particular embodiment of a reactor of the type shown in FIG. 5, the reactor may have vanes on the inside of the reactor at the inlet end of the reactor which are so shaped as to change the flow of the gas to a helical path. For example, in the embodiment shown in FIG. 5 such vanes could resemble turbine blades in shape and could be attached to the supporting flange (900) at the entrance to the reactor and extending part of the distance across the gas opening at that point in the reactor.

FIGS. 6A, 6B, 6C and 6D illustrate further arrangements of the mesh electrode for a reactor of the type shown in FIG. 5. In each of FIGS. 6A, 6B, 6C and 6D, the reactor has a dielectric barrier (210) surrounding the inner electrode (220).

In FIG. 6A the mesh electrode (230) is corrugated.

In FIG. 6B the mesh electrode (240) is corrugated and positioned close to the dielectric barrier (210) so that it touches the dielectric barrier at points around the barrier.

In FIG. 6C the mesh electrode (250,260) has two layers of mesh. The outer layer (260) forms a concentric cylinder around the inner electrode (220) and dielectric barrier (210). The inner layer of the mesh electrode (260) is corrugated and touches the outer layer at points (strips) around the cylinder. The two layers of mesh may be made of the same or different mesh materials.

In FIG. 6D the mesh electrode (270,280,290) forms a concentric cylinder around the inner electrode (220) and dielectric barrier (210). The mesh electrode is made of two cylindrical layers (270,290) of mesh material with a layer of corrugated mesh material (280) in between. The corrugations of the layer 280 touch both the inner mesh layer (290) and the outer mesh layer (270).

Alternative combinations of meshes and dielectric barriers may be used. For example, in FIG. 5, the outer and inner electrodes can be reversed so that the inner electrode 220 is made of mesh and does not have a dielectric barrier in contact with it. Instead the dielectric barrier surrounds the inner surface of the outer electrode 230. Gaseous medium can be passed into the space between the electrodes and can then leave by passing into the centre of the inner electrode. Again, any combination of corrugated or layered mesh may be used for the electrode made of mesh.

It will be appreciated that the types of electrode made of mesh material described above can also be used in reactors of any other geometry. For example, they are also suitable for use in a reactor where the electrodes are in the form of flat plates.

The plasma reactors described herein are suitable for the treatment of chemical warfare gases such as sarin, phosgene and other toxic components used in chemical weapons as well as the destruction of nerve agents and biological agents such as spores, for example anthrax spores, bacteria and viruses, naturally occurring or modified by genetic engineering techniques or combinations of chemical warfare gases and biological agents. It may be part of a system for the detection and treatment of gases and agents other than the emissions from internal combustion engines. The system can include sensors for the detection of such gases and agents and these sensors can be based on microfabricated cantilevers for example as disclosed in WO 99/38007 and WO 00/14539. The plasma reactor can be run continuously or intermittently depending on the response of the sensor. Catalysts can be incorporated into the system downstream of the exhaust gases emitted from the plasma reactor for the conversion of nitrogen oxides, produced in the plasma, to nitrogen. Applications of the plasma reactors described herein also include treatment of volatile organic compounds (VOC), improving air quality for automotive, military and other transport applications as well as in buildings and chemical processing applications. The plasma reactor can be combined with other treatment systems for removal of pollutants for example it may be combined with ozone removal catalysts.

The present invention will now be described further by way of example.

### EXAMPLE 1

Experiments were performed on a reactor of the type shown in FIG. 5. The mesh electrode was made of stainless steel cloth manufactured by Bopp & Co. Ltd. The material had an absolute filter rating of 12-14 microns, a nominal filter rating of 5 microns and a wire cloth specification (warp/weft) of 200×1400. The cloth was attached by continuous welds to the supports in the reactor.

Diluted exhaust gas in the ratio 5:1 (air:exhaust) was passed into the reactor at 54 l/min. The particulate concentration in the gas stream was about 0.04 g/hr. The exhaust gases were produced by a small diesel generator. Exhaust gases taken from a slip-stream from the generator were mixed with air in a heated mixing chamber before being fed to the reactor. As the reactor filters out particulates the flow resistance increases. A mass flow controller was used to maintain the flow of the air added to dilute the exhaust gas and keep it constant. Thus, as the flow resistance increases the exhaust gas preferentially passes down the main exhaust stream (rather than into the reactor). The composition of gas entering the reactor is thus not constant.

The test was performed using exhaust gases at 200° C. and 350° C. The results at 200° C. are shown in FIG. 7A and the results at 350° C. are shown in FIG. 7B.

The differential pressure across the reactor reduced when the voltage was applied across the electrodes and the plasma was created. The change in differential pressure with time is shown in FIGS. 7A and 7B. These Figures show clearly that when no plasma is applied the differential pressure increases as the particulates build up on the mesh electrode. However, when plasma is applied the differential pressure decreases indicating that the particulates are being oxidised.

We claim:

1. A reactor for non-thermal plasma assisted treatment of a gaseous medium, which reactor comprises electrodes defining a space therebetween, through which space gaseous medium is passed in use of the reactor, at least one dielectric barrier layer arranged to provide for a non-thermal plasma of the type referred to as a dielectric barrier type discharge, when an electrical power supply is connected to the electrodes to apply an electrical potential across the said space, and at least one electrically conducting mesh filter element positioned so that the gaseous medium passes therethrough.

2. A reactor as claimed in claim 1 wherein at least one electrically conducting mesh filter element extends across the said space.

3. A reactor as claimed in claim 2, wherein there are two dielectric barrier layers, one on each side of the said space, and the or each mesh filter element extends across the space and into contact with each of the respective dielectric barrier layers.

4. A reactor as claimed in any of the preceding claims, wherein the or each mesh filter element has a curved configuration.

5. A reactor as claimed in any of the preceding claims, wherein the or each mesh filter element has a corrugated form.

6. A reactor as claimed in claim 2, wherein there is a single dielectric barrier layer and the or each mesh filter element extends from contact with the dielectric barrier layer across the said space and into physical and electrical contact with an electrode, thereby causing an intensification of plasma formation in the neighbourhood of contact between the or each mesh electrode and the dielectric barrier layer.

7. A reactor as claimed in claim 6, wherein the or each mesh filter element is inclined at an angle to the surface of the dielectric barrier layer.

8. A reactor as claimed in claim 7, wherein there is a plurality of such inclined mesh filter elements spaced apart.

9. A reactor as claimed in claim 8, wherein the mesh filter elements are arranged so that there is no overlap of the projection onto the dielectric barrier layer of one mesh filter element with the projection of an adjacent mesh filter element.

10. A reactor as claimed in claim 8, wherein the arrangement is such that there is overlap between such projections of adjacent mesh filter elements whereby formation of plasma is concentrated in a region between the extent of the dielectric barrier layer from the point of contact therewith of one mesh filter element to the point of contact therewith of the next adjacent mesh filter element and the acutely inclined surface of one of the said adjacent mesh filter elements.

11. A reactor as claimed in claim 1 wherein the reactor comprises two electrodes and the gaseous medium leaves the space between the said electrodes through an electrode at least part of which comprises a mesh material which thereby provides a said mesh filter element.

12. A reactor as claimed in claim 11 wherein the reactor comprises further electrodes and each pair of electrodes is provided with a dielectric barrier therebetween.

13. A reactor as claimed in claim 11 or 12 wherein the space between the electrodes is empty apart from said dielectric barrier.

14. A reactor as claimed in claim 13 wherein the reactor comprises two concentric electrodes and at least part of the outer electrode comprises a mesh material.

15. A reactor as claimed in any of claims 11 to 14 wherein the electrode at least part of which comprises a mesh material is corrugated.

16. A reactor as claimed in claim 11 or 12 wherein a filling material is present in the space between the electrodes.

17. A reactor as claimed in claim 17 wherein the filling material is a sintered dielectric fibre material.

18. A reactor as claimed in claim 16 wherein the filling material is coated with a catalyst for the conversion of NO to NO₂ or NOₓ (NO and NO₂) to N₂.

19. A reactor as claimed in claim 16 wherein the electrode comprising a mesh filter element has a greater filtration ability per unit thickness than the filling material in the reactor.

20. A reactor as claimed in any of the preceding claims, wherein the aperture size of the or each mesh filter element is chosen to achieve efficient filtration while controlling back pressure and durability of the filter element.

21. A reactor as claimed in claim 20, wherein there is provided a plurality of mesh filter elements with a graded variation in mesh aperture size along the length of the flow path for the gaseous medium.

22. A reactor as claimed in claim 21, wherein the said graded variation is such as to reduce progressively the aperture size in the direction of gas flow.

23. A reactor as claimed in any of the preceding claims, wherein the, or some, or all of the, mesh filter elements is provided with a catalyst surface coating to act as a carbon combustion catalyst to aid removal of trapped particulates.

24. A method for processing a gaseous medium which method comprises passing the gaseous medium through a reactor as claimed in any of claims 1 to 23.

25. A method as claimed in claim 24 wherein the gaseous medium is further treated to remove carbon monoxide.

26. Use of a reactor as claimed in any of claims 1 to 23 for processing a gaseous medium.
